(19) United States
(12) Patent Application Publication
(10) Pub. No.: US 2007/0164624 A1
(43) Pub. Date: Jul. 19, 2007

(54) Positioning ring structure for motor

(75) Inventors: Alex Horng, Kaohsiung (TW); Shih-Chang Huang, Kaohsiung (TW)

Correspondence Address: BIRCH STEWART KOLASCH & BIRCH, PO BOX 747, FALLS CHURCH, VA, 22040-0747, US

(73) Assignee: Sunonwealth Electric Machine Industry Co., Ltd.

(21) Appl. No.: 11/431,559

(22) Filed: May 11, 2006

(30) Foreign Application Priority Data
Jan. 19, 2006 (TW) 095102116

(51) Int. Cl. H02K 5/16; F04B 17/00; F16C 19/50

(52) U.S. Cl. 310/90; 417/423.12; 384/512

(57) ABSTRACT

A positioning ring structure for a motor includes an axial tube, a bearing mounted in the axial tube, and a positioning ring mounted in the axial tube for retaining the bearing in place. The positioning ring includes a central hole extended through by a shaft. The positioning ring includes at least one circulating hole facing an inner circumferential wall of the axial tube. The circulating hole is a through-hole. The lubricating oil that has flowed outward via the central hole of the positioning ring flows back into the axial tube via the circulating hole. Thus, the circulating hole provides a circulating path for the lubricating oil, prevents outflow and loss of the lubricating oil, protects the motor by preventing wear to the shaft and the bearing, and prolongs the life of the motor.

### BACKGROUND OF THE INVENTION

1. Field of the Invention

The present invention relates to a positioning ring structure for a motor. More particularly, the present invention relates to a positioning ring structure for a motor that allows circulation of lubricating oil, thereby preventing outflow and loss of the lubricating oil, protecting the motor by preventing wear to the shaft and the bearing, and prolonging the life of the motor.

2. Description of Related Art

Lubricating oil provides lubrication for a shaft that rotates relative to a bearing for the purposes of reducing frictional force between the shaft and the bearing. Better circulation of the lubricating oil and loss-prevention of the lubricating oil are the keys to the reduced operational noise of the motor and to the prolonged life of the motor.

FIG. 1 illustrates a motor with a conventional positioning ring structure. A bearing 20 is fixed in an axial tube 10 and sandwiched between a positioning ring 40 and an end cap 50. A retaining plate 60 is sandwiched between the end cap 50 and the bearing 20.

The shaft 30 includes an annular groove 31 in an end thereof. When the shaft 30 is extended through a central hole 41 of the positioning ring 40 and the axial hole 21 of the bearing 20, the shaft 30 is retained in place by the retaining plate 60 that is engaged in the annular groove 31. Thus, the shaft 30 may rotate in the axial hole 21 of the bearing 20 without the risk of disengagement.

Lubricating efficiency and preservation of the lubricating oil are the main factors of the life of the motor. During rotation of the shaft 30, the lubricating oil moves upward and finally leaks via the central hole 41 of the positioning ring 40. Since there is no path for the lubricating oil to flow back, the leaked lubricating oil accumulates at the positioning ring 40 and could not flow back to the surface of the bearing 20 for circulating and lubricating purposes. Hence, the motor lacks lubrication and thus generates noise during operation. The life of the motor is thus shortened.

It is therefore a need to prevent outflow and loss of the lubricating oil for the purposes of preventing wear to the shaft and the bearing, of protecting the motor, and of prolonging the life of the motor. Also needed is a lubricating oil circulating system allowing continuous circulation of the lubricating oil.

### SUMMARY OF THE INVENTION

A positioning ring structure for a motor in accordance with the present invention includes an axial tube, a bearing mounted in the axial tube, and a positioning ring mounted in the axial tube for retaining the bearing in place. The positioning ring includes a central hole adapted to be extended through by a shaft. The positioning ring includes at least one circulating hole facing an inner circumferential wall of the axial tube. The at least one circulating hole is a through-hole.

In an embodiment, the positioning ring includes an upwardly extending annular wall, forming a circular shallow basin with the central hole. The at least one circulating hole extends from an outer circumferential surface of the annular wall through an inner circumferential surface of the annular wall.

By such an arrangement, the lubricating oil that has flowed outward via the central hole of the positioning ring flows back into the axial tube via the at least one circulating hole under the action of pumping effect inside the axial tube. Thus, the at least one circulating hole provides at least one circulating path for the lubricating oil, prevents outflow and loss of the lubricating oil, protects the motor by preventing wear to the shaft and the bearing, and prolongs the life of the motor. Also, the noise generated during operation of the motor is lowered.

Other objects, advantages and novel features of this invention will become more apparent from the following detailed description when taken in conjunction with the accompanying drawings.

### BRIEF DESCRIPTION OF THE DRAWINGS

FIG. 1 is a sectional view illustrating a motor with a conventional positioning ring structure;

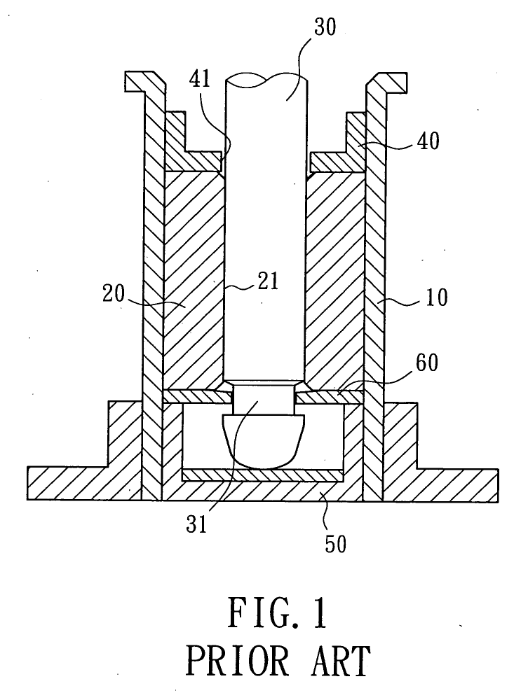

FIG. 2 is an exploded perspective view illustrating a motor with a first embodiment of a positioning ring structure in accordance with the present invention;

FIG. 3 is a sectional view of the motor in FIG. 2;

FIG. 4 is an exploded sectional view illustrating a motor with a second embodiment of the positioning ring structure in accordance with the present invention; and

FIG. 5 is a sectional view of the motor in FIG. 4.

### DETAILED DESCRIPTION OF THE PREFERRED EMBODIMENTS

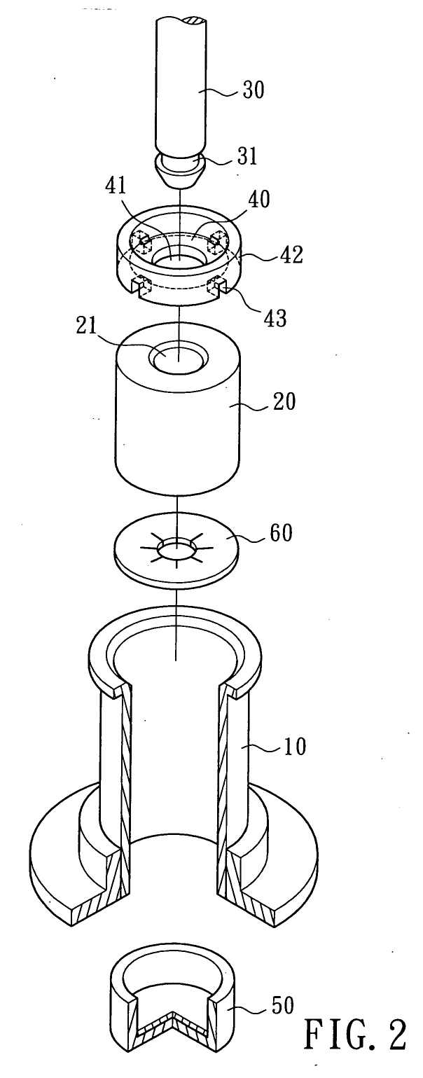

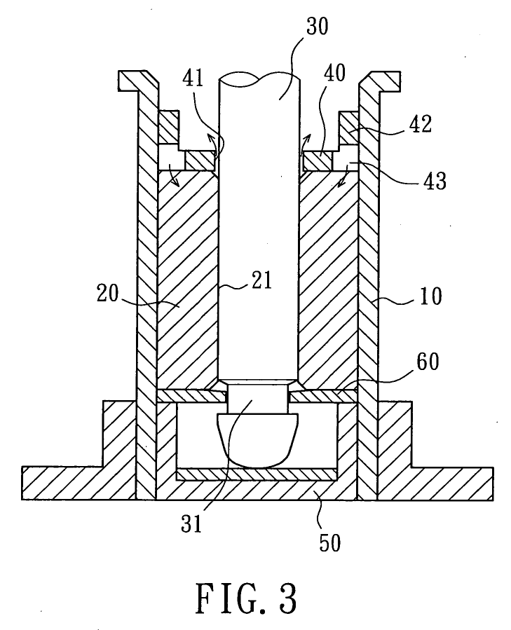

FIGS. 2 and 3 illustrate a first embodiment a positioning ring structure for a motor in accordance with the present invention. The positioning ring structure comprises an axial tube 10 in which an end cap 50, a retaining plate 60, a bearing 20, and a positioning ring 40 are mounted. The end cap 50 and the positioning ring 40 are in tight fit with an inner circumferential wall of the axial tube 10 and respectively located in two ends of the axial tube 10. Hence, the retaining plate 60 and the bearing 20 are arranged in desired positions in the axial tube 10.

A shaft 30 includes an annular groove 31 in an end thereof. The shaft 30 is extended through a central hole 41 of the positioning ring 40 and an axial hole 21 of the bearing 20 in sequence. The retaining plate 60 is engaged in the annular groove 31 of the shaft 30, preventing disengagement of the shaft 30 while the shaft 30 is rotating in the axial hole 21 of the bearing 20.

In this embodiment, the positioning ring 40 includes an upwardly extending annular wall 42, forming a circular shallow basin with a central hole 41. The annular wall 42 includes at least one circulating hole (four in this embodiment) 43 connecting between an outer circumferential surface of the annular wall 42 and an inner circumferential surface of the annular wall 42. The circulating holes 43 face the inner circumferential wall of the axial tube 10.

By such an arrangement, the lubricating oil that has flowed outward via the central hole 41 of the positioning ring 40 flows back into the axial tube 10 via the circulating holes 43 under the action of pumping effect inside the axial tube 10. Thus, the circulating holes 43 provide circulating paths for the lubricating oil, prevent outflow and loss of the lubricating oil, protect the motor by preventing wear to the shaft 30 and the bearing 20, and prolong the life of the motor. Also, the noise generated during operation of the motor is lowered.

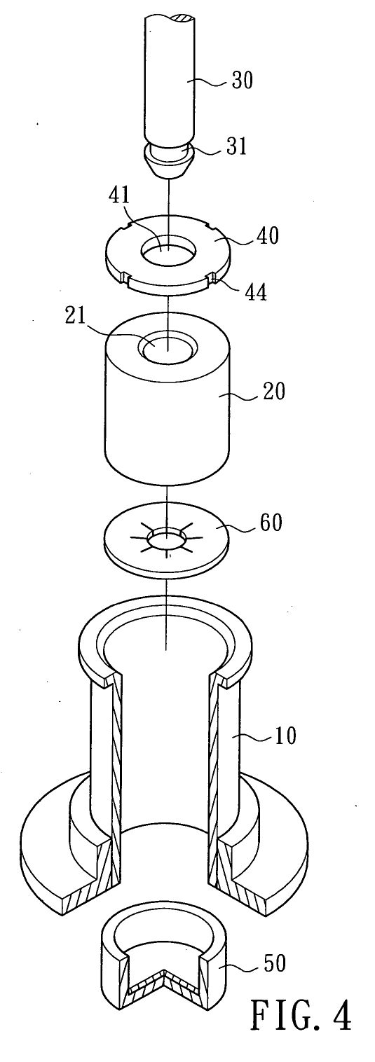

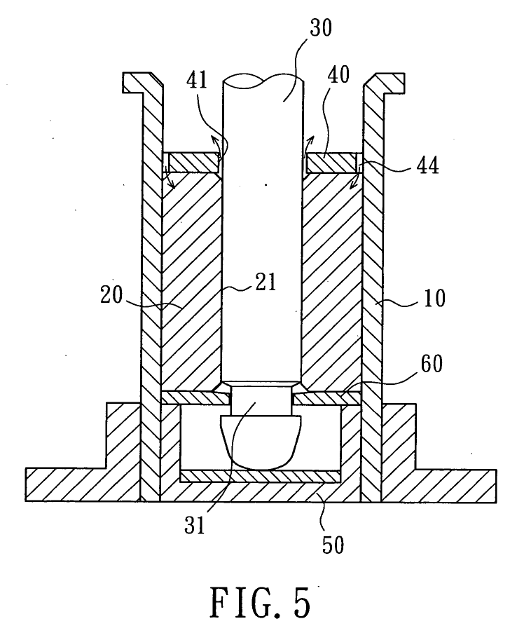

FIGS. 4 and 5 illustrate a second embodiment of the present invention. In this embodiment, the positioning ring 40 is substantially a ring with a central hole 41. At least one circulating hole (four in this embodiment) 44 is defined in an outer circumference of the positioning ring 40 and faces the inner circumferential wall of the axial tube 10. The circulating holes 44 connect between an end face of the positioning ring 40 and the other end face of the positioning ring 40.

By such an arrangement, the lubricating oil that has flowed outward via the central hole 41 of the positioning ring 40 flows back into the axial tube 10 via the circulating holes 44 under the action of pumping effect inside the axial tube 10. Thus, the circulating holes 44 provide circulating paths for the lubricating oil, prevent outflow and loss of the lubricating oil, protect the motor by preventing wear to the shaft 30 and the bearing 20, and prolong the life of the motor. Also, the noise generated during operation of the motor is lowered.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A positioning ring structure for a motor, comprising:
an axial tube;
a bearing mounted in the axial tube; and
a positioning ring mounted in the axial tube for retaining the bearing in place, the positioning ring including a central hole adapted to be extended through by a shaft, the positioning ring including at least one circulating hole facing an inner circumferential wall of the axial tube, said at least one circulating hole being a through-hole.

2. The positioning ring structure for a motor as claimed in claim 1 wherein the positioning ring includes an upwardly extending annular wall, forming a circular shallow basin with the central hole, said at least one circulating hole connecting between an outer circumferential surface of the annular wall and an inner circumferential surface of the annular wall.
